(19) United States
(12) Patent Application Publication
(10) Pub. No.: US 2009/0255871 A1
(43) Pub. Date: Oct. 15, 2009

(54) Method and apparatus for on-site treatment of waste water

(76) Inventor: Tommy Mack Davis, Spartanburg, SC (US)

Correspondence Address: TED M. ANTHONY;BABINEAUX, POCHE, ANTHONY & SLAVICH, L.L.C, P.O. DRAWER 52169, LAFAYETTE, LA, 70505-2169, US

(21) Appl. No.: 12/384,959

(22) Filed: Apr. 10, 2009

Related U.S. Application Data
(60) Provisional application No. 61/123,698, filed on Apr. 10, 2008.

(51) Int. Cl. C02F 3/00

(52) U.S. Cl. 210/615

(57) ABSTRACT

A method and apparatus is provided for continuous microbial seeding of waste-laden water directly within septic tanks and similar treatment facilities in order to improve quality of effluent discharge, thereby reducing or eliminating problems commonly associated with such effluent (including, but necessarily limited to, clogging of conventional drain fields). Waste water to be treated flows into a multi-chambered treatment tank. At least one bio-reactor is installed in such tank, and provides for in-situ growth of desired microbial populations within said tank. The present invention allows for demand growth and improved mineralization of wastes both inside the tank, as well as downstream of the treatment tank.

### CROSS REFERENCES TO RELATED APPLICATIONS

This application claims the benefit of, and priority from, U.S. provisional patent application Ser. No. 61/123,698 filed Apr. 10, 2008, which is incorporated by reference herein.

### STATEMENTS AS TO THE RIGHTS TO THE INVENTION MADE UNDER FEDERALLY SPONSORED RESEARCH AND DEVELOPMENT: NONE

INVENTOR: Tommy Mack Davis

### BACKGROUND OF THE INVENTION

1. Field of the Invention

The present invention pertains to a method and apparatus for the treatment of waste water. More particularly, the present invention pertains to the quality of effluent waste water discharged and/or originating from septic tanks and other similar facilities. More particularly still, the present invention pertains to a method and apparatus for improving quality of waste water discharged from septic tanks, reducing build-up of residual solids in septic tanks, and reducing the clogging and other problems associated with conventional drain fields.

2. Brief Description of the Prior Art

Conventional water treatment systems, in general, and commercial and residential wastewater treatment systems, in particular, can suffer from a number of common problems. One especially prevalent problem is poor quality waste water effluent that is discharged from such systems. Such poor quality waste water effluent, especially effluent from septic tanks and similar facilities, can-frequently fail to meet regulatory standards, and can cause downstream drain fields to become clogged or otherwise obstructed.

Although other sources can be envisioned, waste water frequently originates from sinks, toilets, bath tubs, showers, washing machines, dish washers, kitchens and/or garbage disposals. In the case of residential waste water, the constituent concentrations of typical residential waste water sources are set forth in the following table:

TABLE 1
Constituent Concentrations In Typical Residential Wastewater (1)

| Constituent | Abbreviation | Unit | Range |
|---|---|---|---|
| Total Solids | TS | Mg/l | 500-800 |
| Volatile Solids | VS | Mg/l | 280-375 |
| Total Suspended Solids | TSS | Mg/l | 155-330 |
| Volatile Suspended Solids | VSS | Mg/l | 110-265 |
| 5-day Biochemical Oxygen Demand | BOD5 | Mg/l | 155-286 |
| Chemical Oxygen Demand | COD | Mg/l | 500-660 |
| Total Nitrogen | TN | Mg/l | 26-75 |
| Ammonia | NH4 | Mg/l | 4-13 |
| Nitrites and Nitrates | NO2-NO3 | Mg/l | <1.0 |
| Total Phosphorus | TP | Mg/l | 6-12 |
| Fats, Oils, and Grease | O&G | Mg/l | 70-105 |
| Volatile Organic Compounds | VOC | Mg/l | 0.1-0.3 |
| Surfactants | — | Mg/l | 9-18 |
| Total Coliform | TC | Mg/l | 10⁸-10¹⁰ |
| Fecal Coliform | FC | Mg/l | 10⁶-10⁸ |
| pH | — | Su | 6-7.5 |
| Temperature | T | ° F. | 60-100 |

### From Table 3-7, USEPA “Onsite Wastewater Treatment Systems Manual”, EPA/625/R-00/008, February, 2002.

It is well known that certain microbes can be used to naturally mineralize and/or break down organic matter into harmless, environmentally-friendly elements (such as, for example, carbon dioxide and water). Furthermore, it is also well known that certain microbes can be used to beneficially control or eliminate malodorous and/or toxic elements found in certain waste streams, including effluent from waste water treatment facilities. However, to date, existing microbial treatment methods have not been used to effectively or reliably treat waste water discharged from septic tanks or other similar facilities. Significantly, such prior art methods and devices still require periodic addition—that is “dosing”—of microbial cultures directly into the environment to be treated. Without such repeated dosing, such beneficial microbial populations will not remain at effective levels, and the desired treatment effect will not-be maintained. Moreover, such prior art methods are focused exclusively on use of the beneficial microbial population(s) only within the septic tank or other waste water treatment facility; no effort is made to actively spread such beneficial microbial population(s) via the discharged effluent stream in order to improve the performance of drain fields and/or other downstream facilities.

Thus, there is a need for an inexpensive, effective and reliable means for beneficially using microbes to improve the quality of effluent discharged from septic tanks and/or other waste water treatment facilities. Such microbial population(s) must be able to beneficially attack organic materials for waste remediation purposes in a manner that overcomes limitations associated with existing microbial waste treatment systems. Further, beneficial microbial population(s) should be discharged along with the effluent stream to continue mineralizing wastes downstream of the septic tanks and/or other waste treatment facilities, thereby improving performance of drain fields.

### SUMMARY OF THE PRESENT INVENTION

The present invention comprises a method and apparatus for continuous microbial seeding of waste-laden water directly within septic tanks and similar treatment facilities in order to improve effluent discharge quality, thereby reducing or eliminating problems commonly associated with such effluent (including, but necessarily limited to, clogging of conventional drain fields). By promoting in-situ growth of desired microbial populations directly within an environment to be treated, the present invention allows for demand growth and microbial acclimation within said environment. Because the microbial agents generated by the present invention are provided with a continuous supply of oxygen, such microbial agents can more effectively mineralize waste within a particular treatment environment. Performance of the present invention far surpasses performance of existing methods of waste water treatment that employ periodic “dosing” of microbial populations.

In the preferred embodiment, the present invention comprises a treatment system that improves the quality of septic tank effluent by reduction and/or control of undesirable elements including, but not necessarily limited to, carbonaceous biochemical oxygen demand (“CBOD5”), grease, and total suspended solids (“TSS”). In the preferred embodiment, the apparatus of the present invention comprises a septic treatment tank having at least two chambers (embodying a design well known to those skilled in the art), an in-situ bio-reactor, effluent filter device, air supply pump, recirculation piping and a control panel. Although the present invention is described herein for illustration purposes in connection with a septic tank, the present invention is suitable for use on many different locations including, without limitation, single or multi-family dwellings, commercial installations and seasonally occupied homes.

In operation, wastewater to be treated enters a first chamber of a septic tank where contaminants begin to degrade under anaerobic conditions. Suspended solids tend to settle to the bottom of said chamber, while grease and other lighter elements tend to float on the upper surface of the water in said first chamber. Partially treated wastewater from the first chamber flows into a second chamber through a baffle arrangement well known to those having skill in the art of septic tank design.

In the preferred embodiment, a microbial bio-reactor unit is contained within said second chamber of said septic tank, and submerged directly within the waste-laden liquids within said second chamber. In the preferred embodiment, the bio-reactor of the present invention typically comprises a permeable container or basket, such as a perforated or screened-cylinder, containing biocarrier media (typically having high surface area) having beneficial microbial population(s) immobilized on the surface of such biocarrier media. Such beneficial microbial population(s) are typically non-pathogenic, food grade microorganisms that reduce the concentrations of CBOD5 and TSS and other constituents to desired standards including, without limitation, NSF/ANSI 40-2005 standards.

Perforations or openings in said bio-reactor container permit liquid flow therethrough, but prevent biocarrier media from escaping or exiting said container. In the preferred embodiment, a conduit and diffuser apparatus extend into said container to provide an air supply to the microbial population(s) immobilized on the surface of said biocarrier media. Over time, the microbial growth provided by the present invention can result in the spread of beneficial microbial agents throughout the chambers of said septic tank or other similar unit containing said bio-reactor, and also downstream to drain fields and the like via the effluent stream.

Within the inner bore or chamber of said bio-reactor container, said diffuser extends substantially along the entire length of the device. In the preferred embodiment, said conduit and diffuser are constructed of inert piping or tubing; said conduit and diffuser can be constructed from tubing that is commercially available in varying rigidity, diameters and lengths. Generally, the rigidity, diameter and length of the conduit and diffuser is dictated by the specific air supply used and its proximity to the bio-reactor unit.

Microbial population(s) specific to the degradation of waste(s) to be encountered within the particular environment being treated are beneficially selected and used. In the preferred embodiment, said microbial population(s) are immobilized on the surface of the biocarrier media. Such biocarrier media is ideally loaded within the inner bore of said bio-reactor so that it substantially covers or engulfs all or substantially all of the diffuser which extends along the length of said bio-reactor container.

Air is supplied to microbial population(s) immobilized on the surface of the biocarrier media loaded within the bio-reactor container. Air is transported through said conduit and into the diffuser which extends substantially along the length of the bio-reactor container of the present invention. In most cases, waste material present in a septic tank contains ample quantities of nitrogen and/or other nutrients, making it unnecessary to supply additional nutrients to such microbial cultures.

Air introduced into the bio-reactor container serves to oxygenate beneficial microbial population(s) immobilized on the surface of the biocarrier media. Such oxygenation permits increased respiration by, and population expansion of, such beneficial microbes. Ultimately, such oxygenation allows the desired microbial population(s) to thrive, thereby resulting in optimized mineralization of waste products within an environment being treated, as well as the spreading of such microbial population(s) to downstream drain fields via effluent discharged from the treatment facility.

In the preferred embodiment of the present invention, a portion of the flow stream entering the second chamber of the septic tank is circulated back to the first chamber of said septic tank. Such circulation can be accomplished by a submersible pump or air lift system using air supplied by a linear air pump. Such circulated flow stream beneficially includes microbes that have migrated from the bio-reactor to the fluid column surrounding said bio-reactor. Microbes circulated into the first chamber assist in breaking down solids settled on the bottom of the first chamber, and assist in degrading grease or other elements floating on the upper surface of the liquid in said first chamber.

A removable filter is situated in proximity to the effluent outlet in the second chamber of the septic tank. Said filter traps TSS larger than a desired size (in the preferred embodiment, 1/16″) and prevents said TSS from exiting the septic tank and entering the drain field. Said filter is beneficially designed to be accessible so that it can be removed, cleaned, and replaced, as needed.

A high water level float switch is situated at a beneficial location in the first chamber of the septic tank to provide an alarm if the water level in the septic tank exceeds a desired level. In the preferred embodiment, said float switch is connected by an electrical circuit to an alarm light and horn on the control panel.

In the preferred embodiment, the control panel for the system is weather proof, and can be mounted either on the outside or inside of garages and out buildings, or can be pole-mounted in the vicinity of the treatment system of the present invention. In the preferred embodiment, said control panel is powered by a single 120 volt, 15 amp circuit and contains the following alarm functions: 120V/24V alarm function UPS unit, 24 volt battery for loss of power alarm, high water level in the septic tank, loss of power to the control panel, loss of air pressure to the bioreactor, alarm horn with 1 to 5 minute adjustable timer, alarm horn disable switch, alarm light that can burn continuously until the alarm condition is cleared.

In the preferred embodiment, waste treatment is not limited exclusively to activity within the septic tank. Beneficial microbial cultures in the water column of the second chamber of said septic tank will frequently pass through said filter, exit said septic tank and populate drain field(s) downstream of said septic tank outlet. Such microbes can degrade grease, slime and solids that may be trapped in the filter media and the drainage media, as well as in the pores of the drain field soil. Over time, said microbial cultures serve to maintain the absorption capacity of new drain fields, and restore and maintain the absorption capacity of existing drain fields.

In the preferred embodiment, the treatment results from the system of the present invention can satisfy applicable regulatory standards, such as “secondary” treatment quality meeting NSF/ANSI 40-2005 Class 1 criteria. Further, the treatment system of the present invention cam meet this quality standard treating waste water at an average seven-day flow rate of at least 440 gallons per day, which is generally equivalent to the flow from a single family four bedroom home.

In the preferred embodiment, effluent from the treatment system of the present invention meets or exceeds the following limits, and criteria for samples taken as 24-hour composite samples:

| Constituent | Concentration |
|---|---|
| Carbonaceous 5-day Biochemical | |
| Oxygen Demand (CBOD5) | |
| 30-day Average | Not Exceed 25 mg/L |
| 7-day Average | Not Exceed 40 mg/L |
| Total Suspended Solids (TSS) | |
| 30-day Average | Not Exceed 30 mg/L |
| 7-day Average | Not Exceed 45 mg/L |
| TOTAL NITROGEN (TN) | |
| 30-day Average | <50% of Influent TKN |
| pH | |
| Individual Samples | Between 6.0 and 9.0 su |
| Odor | Non Offensive |
| Oily Film and Foam | Not visually detected in |
| | any diluted composite |
| | samples |

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a perspective partial cut-away view of the waste water treatment apparatus of the present invention.

FIG. 2 depicts a perspective view of a bio-reactor apparatus of the present invention.

FIG. 3 depicts a side sectional view of the bio-reactor apparatus of the present invention.

FIG. 4 depicts a side sectional view of an embodiment waste water treatment apparatus of the present invention as installed.

### DETAILED DESCRIPTION OF A PREFERRED EMBODIMENT OF THE INVENTION

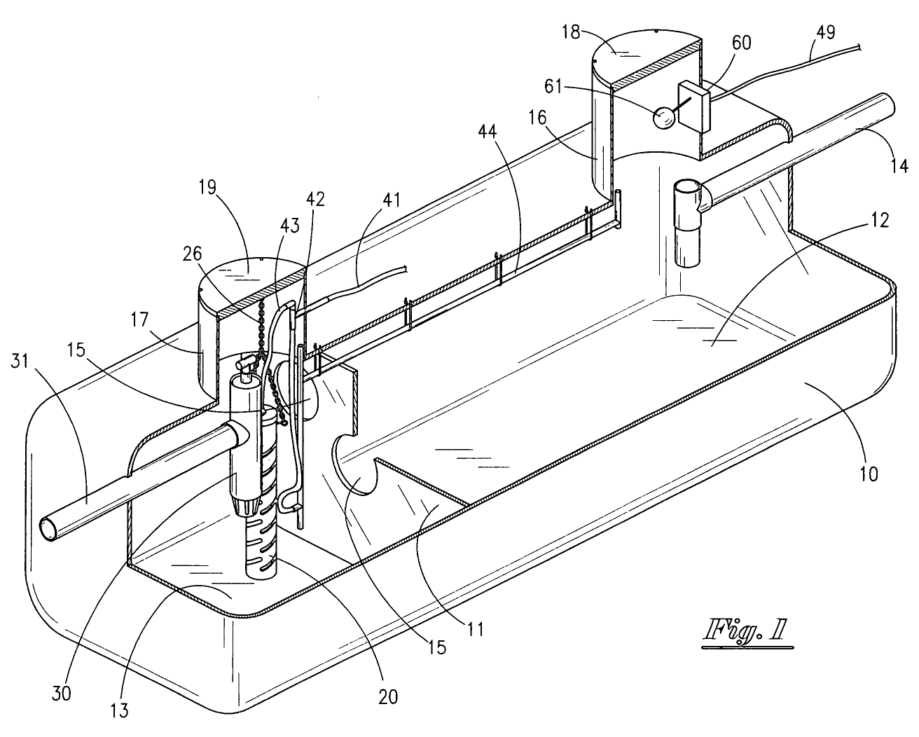

Referring to the drawings, FIG. 1 depicts a perspective, partial cut-away view of an embodiment of the waste water treatment apparatus of the present invention. The present invention improves clarity and quality of effluent discharged from waste water facilities (such as septic tanks and the like), thereby reducing or eliminating problems commonly associated with such effluent, including, but necessarily limited to, clogging of conventional drain fields. Further, because beneficial microbial population(s) are discharged along with the effluent stream, such beneficial microbial population(s) spread downstream of the septic tanks and/or other waste treatment facilities and continue mineralizing wastes, thereby cleaning drain fields and improving the performance of same.

Specifically, the present invention comprises a treatment system that improves the clarity and quality of waste water treatment effluent by reducing and/or controlling undesirable elements including, but not necessarily limited to, carbonaceous biochemical oxygen demand (“CBOD5”), grease, and total suspended solids (“TSS”). Microbial agents are used to effectively mineralize wastes within a particular treatment environment. The present invention promotes in-situ growth of desired microbial population(s) directly within a treatment facility, as well as the spread of beneficial microbial population(s) to downstream drain fields and the like.

Referring to FIG. 1, the waste water treatment apparatus of the present invention comprises treatment tank 10 defining an interior space and having at least two chambers separated by baffle assembly 11, at least one bio-reactor assembly 20 and effluent filter assembly 30. Although not depicted in FIG. 1, it is to be understood that a preferred embodiment of the present invention also comprises at least one air supply pump 40 and at least one control panel 50. Moreover, while waste water treatment apparatus of the present invention is described herein for illustration purposes in connection with a septic tank, it is possible that the present invention could take the form of other waste water treatment applications.

Still referring to FIG. 1, waste water (typically containing some solid waste component) enters a first chamber 12 of treatment tank 10 via fluid inlet line 14. Septic tank 10 also comprises second chamber 13 separated from said first chamber 12 by baffle assembly 11. In the preferred embodiment, said baffle assembly 11 can extend to a desired height below the upper surface of treatment tank 10, ideally to prevent solid components (which typically collect at or near the bottom of first chamber 12) from migrating into second chamber 13, while permitting liquid and gaseous components to transfer into said second chamber 13. Additionally, at least one aperture 15 extends through baffle assembly 11 and provides access between said first chamber 12 and second chamber 13.

In the preferred embodiment, first access port 16 allows access to first chamber 12 of treatment tank 10, while second access port 17 allows access to second chamber 13 of treatment tank 10. Lockable lids 18 and 19 are provided on access ports 16 and 17, respectively, to prevent unwanted and/or unauthorized entry into said treatment tank 10 via access ports 16 and 17. In the preferred embodiment, high level alarm 60 having float switch 61 is disposed within access port 16. Access ports 16 and 17 permit visual inspection into first chamber 12 and second chamber 13 of treatment tank 10, and allow physical access to the various components of the present invention disposed within said treatment tank 10. In the preferred embodiment, access port lids 18 and 19 are beneficially placed at or near ground level, so as not to impede or obstruct passage over treatment tank 10

Still referring to FIG. 1, at least one microbial bio-reactor assembly 20 is disposed within second chamber 13 of septic tank 10. In the preferred embodiment, said bio-reactor assembly 20 is held in place within said septic tank 10 using suspension assembly 26; said suspension assembly 26 suspends bio-reactor assembly 20 from lid 19 and permits submersion of said bio-reactor assembly 20 directly within the waste-laden liquid to be treated within treatment tank 10.

Still referring to FIG. 1, conduit 41 permits delivery of air from an air supply pump 40 (not shown in FIG. 1) to air distribution assembly 42. Air pumped to air distribution assembly 42 can flow to bio-reactor assembly 20 via bio-reactor air supply conduit 43, as well as recirculation assembly 44. Conventional valves in distribution assembly 42 permit selective distribution of air to bio-reactor 20 or recirculation assembly 44, as desired.

Filter assembly 30 is disposed at a desired location within second chamber 13 of treatment tank 10. Fluid discharge line 31 extends from filter assembly 30, and permits flow of effluent from treatment tank 10 to downstream components such as, for example, a conventional drain field or the like.

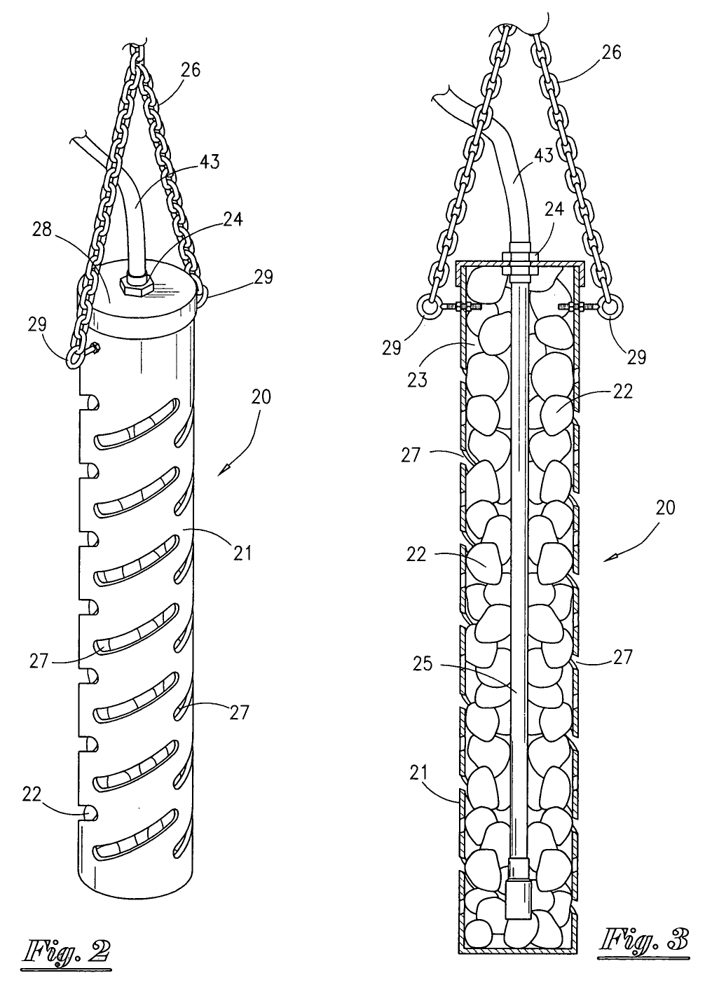

FIG. 2 depicts a perspective view of a bio-reactor assembly 20 of the present invention. In the preferred embodiment, bio-reactor assembly 20 comprises substantially cylindrical housing 21 having a plurality of openings 27 extending through said housing 21. Removable lid 28 is disposed on the upper portion of said housing 21. Mounting shackles 29 are affixed to said housing 21, and connect to suspension assembly 26. Bio-reactor air supply line 43 connects to lid 28 via connection fitting 24.

FIG. 3 depicts a side sectional view of bio-reactor assembly 20 of the present invention. In the preferred embodiment, bio-reactor assembly 20 comprises substantially cylindrical housing 21 defining an inner chamber 23, and having a plurality of openings 27 extending through said housing 21. Removable lid 28 is disposed on the upper portion of said housing 21. Mounting shackles 29 are affixed to said housing 21, and connect to suspension assembly 26. Bio-reactor air supply line 43 connects to lid 28 via connection fitting 24, which in turn connects to ported air diffuser 25.

Beneficial microbial population(s) are immobilized on the surface of at least one support medium, such as biocarrier media 22 disposed within said inner chamber 23. Said biocarrier media 22 ideally has large surface area. Non-pathogenic, food grade microorganisms that reduce the concentrations of CBOD5 and TSS and other constituents to desired standards including, without limitation, NSF/ANSI 40-2005 standards, are immobilized on such surface area. Openings 27 in housing 21 permit liquid flow through said housing (into and out of said inner chamber 23). However, said openings 27 in said housing 21 are sized to prevent biocarrier media 22 from escaping or leaving inner chamber 23 of housing 21 via openings 27.

Beneficial microorganisms are immobilized on and attached to biocarrier media 22, which serves as a support or substrate for such microorganisms. Such immobilized beneficial microorganisms are suitable for conducting continuous biochemical reactions, especially low energy biochemical reactions useful for the mineralization of wastes brought into contact therewith.

Still referring to FIG. 3, bio-reactor air supply line 43 and diffuser apparatus 25 extend into inner chamber 23 of housing 21, and permit air and/or nutrients to reach microbial populations immobilized on the surface of said biocarrier media 22. Over time, in-situ microbial growth of beneficial microbes can result in the spread of beneficial microbial agents throughout the system(s) being treated including, without limitation, chambers 12 and 13 of septic treatment tank 10 (or other treatment unit containing said bio-reactor). Importantly, the present invention further facilitates spread of such beneficial microbial agents downstream of septic treatment tank 10 via effluent discharged through fluid discharge line 31.

Diffuser 25 extends substantially along the entire length of inner chamber 23 of housing 21. In the preferred embodiment, bio-reactor air supply line 43 and diffuser 25 are constructed of inert piping or tubing. Generally, the rigidity, diameter and length of bio-reactor supply line 43 and diffuser 25 are dictated by the specific air supply used, as well as the proximity of said air supply to bio-reactor assembly 20.

Biocarrier media 22 is disposed within inner chamber 23 of bio-reactor housing 21. Microbial population(s) specific to the degradation of waste(s) to be encountered within the particular environment being treated are immobilized on the surface of such biocarrier media. Further, said biocarrier media 22 is ideally loaded within the inner chamber 23 of bio-reactor housing 21 so that it covers substantially all of diffuser 25.

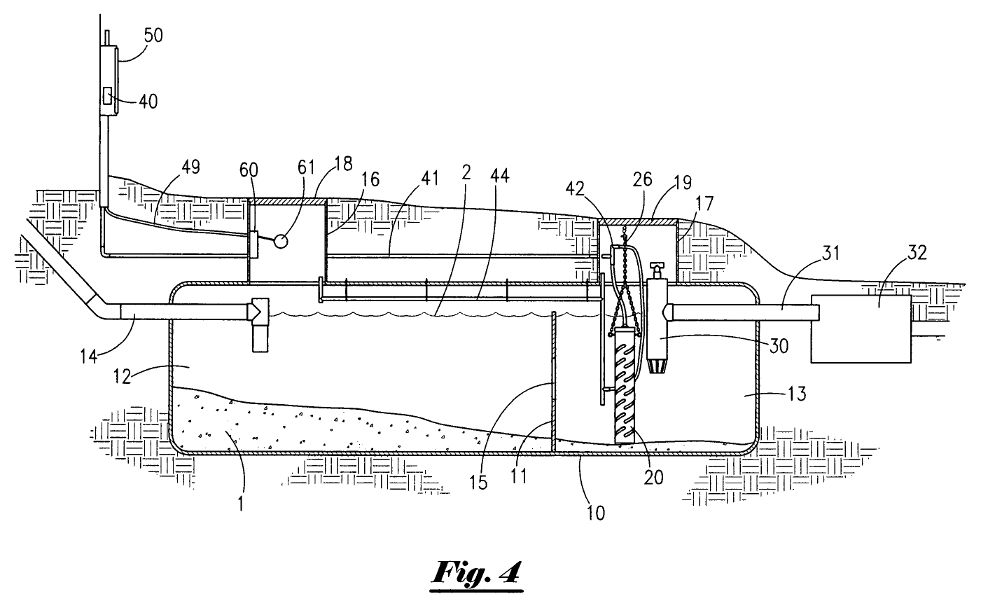

FIG. 4 depicts a side sectional view of an installed embodiment waste water treatment apparatus of the present invention including subterranean treatment tank 10. In the embodiment depicted in FIG. 4, treatment tank 10 is buried at a convenient location, as is commonly the case with conventional septic tank units and the like. Treatment tank 10 defines an interior space and having at least two chambers (first chamber 12 and second chamber 13) separated by baffle assembly 11, at least one bio-reactor assembly 20 and effluent filter assembly 30. At least one air supply pump 40 and at least one control panel 50 are also provided.

First chamber 12 is separated from said second chamber 13 by baffle assembly 11. In the preferred embodiment, said baffle assembly 11 can extend to a desired height below the upper surface of treatment tank 10, ideally to prevent solid components (which typically gravity segregate at or near the bottom of first chamber 12) from migrating into second chamber 13, while permitting liquid and gaseous components access into said second chamber 13. Additionally, at least one aperture 15 extends through baffle assembly 11 to provide access between said first chamber 12 and second chamber 13.

First access port 16 allows access to first chamber 12 of treatment tank 10, while second access port 17 allows access to second chamber 13 of treatment tank 10. Lockable lids 18 and 19 are provided on access ports 16 and 17, respectively. High level alarm 60 having buoyancy float switch 61 is disposed within access port 16. Access port lids 18 and 19 are beneficially placed at or near ground level, and would not impede or obstruct passage over treatment tank 10

Still referring to FIG. 4, at least one microbial bio-reactor assembly 20 is disposed within second chamber 13 of septic tank 10. In the preferred embodiment, said bio-reactor assembly 20 is held in place within said septic tank 10 using suspension assembly 26; said suspension assembly 26 suspends bio-reactor assembly 20 from lid 19 and permits submersion of said bio-reactor assembly 20 directly within the waste-laden liquid to be treated within treatment tank 10. In the preferred embodiment, bio-reactor assembly 20 is suspended vertically within second chamber 13, with the bottom of housing 21 positioned no more than 4 inches above the bottom of treatment tank 10.

Conduit 41 permits delivery of air from air supply pump 40 to air distribution assembly 42. Air pumped to air distribution assembly 42 can flow to bio-reactor assembly 20 via bio-reactor air supply conduit 43, as well as recirculation assembly 44.

Filter assembly 30 is disposed at a desired location within second chamber 13 of treatment tank 10; Fluid discharge line 31 extends from filter assembly 30, and permits flow of effluent from treatment tank 10 to downstream components such as, for example, distribution box 32, or a conventional drain field or the like.

Waste water to be treated (from a residence, for example) enters first chamber 12 of treatment tank 10 via fluid inlet line 14. Heavier solid materials 1 will settle at or near the bottom of first chamber 12, while grease and other lighter materials will float on the upper surface 2 of waste water in said first chamber 12 of septic tank 10. Partially-treated waste water from said first chamber 12 flows into second chamber 13 through aperture(s) 15 of baffle assembly 11.

Organic compounds in the wastewater typically degrade in first chamber 12 under anaerobic conditions, frequently generating organic acids, proteins, sugars, ammonia, and other reduced compounds. Solids 1 that settle to the bottom of said first chamber 12 also degrade under anaerobic conditions reducing the mass weight of said solids, while also producing organic acids and ammonia. Said first chamber 12 of treatment tank 10 generally exhibits a combination of anaerobic treatment, with anoxic zones created by circulation of water from the second compartment (described in detail below). Settled solids 1 in said first chamber typically degrade slowly under anaerobic conditions, while lighter floating solids are exposed to air and are mineralized by microbial population(s) circulated from second chamber 13.

In the preferred embodiment air is supplied to microbial population(s) immobilized on biocarrier media 22 contained within inner chamber 23 of bio-reactor housing 21 using air supply pump 40. In many applications, air supply pump 40 is beneficially situated at or near a residence or other facility being serviced by the present invention, thereby permitting support by existing utilities, as well as easy access to said air supply pump 40 for maintenance and/or repair purposes.

Air flows from air supply pump 40 through conduit 41 and bio-reactor air supply line 43 and into diffuser assembly 25. If desired, nutrients can also be provided to the microbial population(s) present on biocarrier media 22. However, in most cases, waste material(s) commonly present in septic tanks contains ample quantities of nitrogen and/or other nutrients, thereby making it unnecessary to supply additional nutrients to such microbial population(s).

Air introduced into bio-reactor assembly 20 serves to oxygenate microbial population(s) immobilized on the surface of biocarrier media 22. Such oxygenation permits increased respiration by, and population expansion of, beneficial microbes. Ultimately, such oxygenation allows the desired microbial population(s) to thrive, thereby resulting in optimized mineralization of waste products within the environment being treated (chambers 12 and 13 of septic tank 10), as well as areas receiving effluent downstream of said septic tank 10.

In the preferred embodiment of the present invention, a portion of the waste water within second chamber 13 of septic tank 10 is circulated back to first chamber 12 of said septic tank 10. Such circulation can be accomplished by a submersible pump (not depicted in FIG. 4) or recirculation assembly 44 using air supplied by air supply pump 40. Such circulated waste water beneficially includes microbes that have migrated from bio-reactor assembly 20 to the fluid within second chamber 13 surrounding said bio-reactor assembly 20. Microbes within waste water circulated from second chamber 13 into first chamber 12 assist in mineralizing waste materials in said first chamber 12 including, without limitation, solids 1 settled on the bottom of the first chamber, and assist in degrading grease or other lighter materials 2 floating on the upper surface of the liquid within said first chamber 12.

The rate of circulation of waste water from said second chamber 13 to first chamber 12 is controlled by the amount of air introduced into the circulation piping. The greater the air rate, the greater the overall water circulation. In the preferred embodiment, the circulation rate should range between 10 and 20 gallons per hour, with the outlet of recirculation assembly 44 being visible via access port 16.

Removable filter assembly 30 is beneficially situated in proximity to effluent outlet line 31. Said filter assembly filters TSS larger than a desired size (in the preferred embodiment, 1/16″) and prevents said TSS from exiting treatment tank 10 and entering downstream facilities (such as, for example distribution box 32 or drain field). Said filter assembly 30 is beneficially designed to be accessible so that it can be removed, cleaned, and replaced, as needed.

A high fluid level float switch 61 is situated at a beneficial location in access port 16 to provide an alarm if the water level in treatment tank 10 exceeds a desired level. In the preferred embodiment, said float switch 61 is connected by an electrical circuit 49 to an alarm light and horn beneficially situated control panel 50.

In the preferred embodiment, control panel 50 is weather proof, and can be mounted either on the outside or inside of garages and out buildings, or can be pole-mounted in the vicinity of the treatment system of the present invention. In the preferred embodiment, said control panel 50 is powered by a single 120 volt, 15 amp circuit and contains the following alarm functions: 120V/24V alarm function UPS unit, 24 volt battery for loss of power alarm, high water level in the septic tank, loss of power to the control panel, loss of air pressure to the bioreactor, alarm horn with 1 to 5 minute adjustable timer, alarm horn disable switch, alarm light that can burn continuously until the alarm condition is cleared.

In the preferred embodiment, waste treatment is not limited exclusively to activity within treatment tank 10. Beneficial microbial cultures in the water column of second chamber 13 of treatment tank 10 will frequently pass through filter assembly 30, exit treatment tank 10 and populate drain field(s) downstream of effluent discharge line 31. Such microbes can degrade grease and solids that may be trapped in filter assembly 30 and the drainage media, as well as in the pores of the drain field soil. Over time, said microbial cultures serve to maintain the absorption capacity of new drain fields, and restore and maintain the absorption capacity of existing drain fields.

The treatment system of the present invention permits intermittent use, which can commonly occur at residences that are not continuously occupied during the year. By way of example, but not limitation, such residences can include vacation houses, rental properties, apartments and the like. In such cases, the air supply pump 40 should beneficially continue to run; however, the flow rate of air can be reduced to limit power requirements by partially closing a throttle valve using a control panel. When greater treatment capacity is required (such as, for example, when a residence is re-occupied), such air valve to the bio-reactor assembly can be opened.

For residences that are occupied only part of the year or during seasonal periods, microbial population(s) immobilized on the surface of biocarrier media 22 in bio-reactor assembly 20 will typically become dormant when no waste water is being discharged to the treatment tank. However, because such microbial population(s) remain present in said bio-reactor assembly 20 during such periods of inactivity, the microbial population(s) can become active again after waste water discharge is restored to treatment tank 10.

In the event of a power outage, the supply of air to treatment tank 10 may stop and the water in second chamber 13 of treatment tank 10 can become anaerobic, due to a lack of oxygen in such water. In most cases, microbial population(s) present in bio-reactor assembly 20 will be facultative (that is, capable of living in aerobic and anaerobic environment). Such microbial populations will typically become dormant without oxygen present, but will not die. After air (and oxygen) supply is restored, said microbial cultures can convert to an aerobic state and can multiply and mineralize wastes present in the waste water in the treatment tank. In the event that there is an extended power outage, the present invention will frequently continue to treat the waste water in a substantially anaerobic environment.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method of treating waste water comprising:
a. Immobilizing at least one microbial population on a substrate;
b. Placing said substrate within a porous container;
c. Introducing said porous container into said waste water;
d. Supplying oxygen to said container and said at least one microbial population; and
e. mineralizing wastes in said waste water.
